(19) United States
(12) Patent Application Publication
(10) Pub. No.: US 2004/0193518 A1
(43) Pub. Date: Sep. 30, 2004

(54) Method and system for maintenance of an elevator or escalator installation

(75) Inventor: Romeo Deplazes, Oberrueti (CH)

Correspondence Address: OSTROLENK FABER GERB & SOFFEN, 1180 AVENUE OF THE AMERICAS, NEW YORK, NY, 100368403

(73) Assignee: Inventio AG

(21) Appl. No.: 10/804,888

(22) Filed: Mar. 18, 2004

(30) Foreign Application Priority Data
Mar. 26, 2003 (EP) 03 405209.2

(51) Int. Cl. G06F 17/60

(52) U.S. Cl. 705/34

(57) ABSTRACT

A method and a system for maintenance of an elevator or escalator installation via at least one data transfer device, performance-relevant data are transferred from the elevator or escalator installation to a physically separate maintenance center. In the maintenance center the performance-relevant data are linked by at least one data processing system with at least one operating parameter to form an installation capacity utilization. A protocol with respect to the installation capacity utilization is transmitted to the customer by at least one data transfer device.

### BACKGROUND OF THE INVENTION

The invention relates to the field of transport and in that case to a method and system for maintenance of an elevator or escalator installation.

European reference EP 0 252 266 and U.S. Pat. No. 5,450,478 show elevator installations, the elevators of which have, apart from a conventional control device, additionally a modem for remote monitoring. In this remote monitoring each control device of an elevator installation communicates under specific conditions with a maintenance center by means of modem by way of a public telephone network. The data exchange taking place in that case relates in the first instance to predefined diagnostic data concerning the operational state of the elevator installation.

In the event of disturbance of the fault-free operational state of an elevator or escalator installation, a maintenance engineer makes a maintenance call to the elevator or escalator installation for the purpose of removing the disturbance. Maintenance services furnished in that case are debited to the customer on the basis of a maintenance contract. The number of calls of the maintenance engineer per accounting period is then a fixed service. In addition, the remedying of a fault is usually a fixed service component of the maintenance contract. Repairs necessary for eliminating a fault as well as the cost of materials occurring in that case are debited to the customer as an additional service. Such additional services are debited to the customer either at a flat rate or on a case to case basis.

It is disadvantageous with this form of maintenance contract that a mixture of fixed services and additional services difficult to estimate in advance is debited. In the terms of individualization of the maintenance contract it is desirable to debit to the customer only for customer services actually used and desired by the customer in an accounting period.

The novel features which are considered as characteristic of the invention are set forth in particular in the appended claims. The invention itself, however, as to its construction and method of operation together with additional objects and advantages thereof will be best understood from the following description of specific embodiments when read in connection with the accompanying drawings.

### SUMMARY OF THE INVENTION

Accordingly, it is an object of the present invention to provide a method and a system for maintenance of an elevator or escalator installation in order to eliminate this disadvantage of mixing of fixed and additional services in the debiting of maintenance work and to realize this wish for individualization of maintenance contracts. This object shall be compatible with known and proven procedures in the field of transport.

According to the invention the method and system for maintenance of an elevator or escalator installation are oriented not to the costs occurring in maintenance, but to the installation capacity utilization resulting through provision of an elevator or escalator installation functioning in fault-free manner.

For ascertaining this installation capacity utilization, the elevator or escalator installation is connected with a maintenance center. The elevator or escalator installation and maintenance centers are physically separate from one another. Performance-relevant data are transferred from the elevator or escalator installation to the maintenance center by means of at least one data transfer device. In the maintenance center the performance-relevant data are linked by means of at least one data processing installation with at least one operating parameter to form an installation capacity utilization. The maintenance center and the customer are physically separate from one another. With respect to the installation capacity utilization, a protocol is transmitted to the customer by means of at least one data transfer device. Advantageously the protocol is transmitted electronically and/or by postal transmission to the customer.

The performance-relevant data of the elevator or escalator installation are thus detected in a remote monitoring, evaluated in a maintenance center in accordance with the operating parameter and converted into an installation capacity utilization according to a maintenance contract.

The maintenance center can communicate to the customer by the protocol numerous customer services corresponding with the individual customer requirement, whereby the customer has a conscious perception of their own customer uses consumed by the installation capacity utilization. Advantageously, the protocol has an invoice for customer service that has been used. Further advantageously, the protocol has the degree of availability of the elevator or escalator installation. Advantageously, the protocol has the total number of journeys of the elevator or escalator installation. Advantageously, the protocol also has the distribution in time or space of the journeys of the elevator or escalator installation. Advantageously, the protocol additionally has the total number of and reasons for disturbances in the elevator or escalator installation. Additionally, advantageously, the protocol has the number of previous maintenance calls and the term of the next maintenance call.

The advantage of the invention resides in the fact that the person instructed with the maintenance of the elevator or escalator installation can obtain through detection and evaluation of these performance-relevant data a deep knowledge with respect to the behaviour, needs and wishes of that person's customers and correspondingly also the same can make concrete and sound proposals for improvements in the maintenance and operation of the elevator or escalator installation. This is of great significance particularly with the multiplicity of maintained elevator or escalator installations. Advantageously, the installation capacity utilization has at least one threshold value. If the threshold value is fallen below or exceeded the installation capacity utilization is sub-optimal, i.e. the availability of the elevator or escalator installation is influenced in a disadvantageous manner. In order to present an upgrading offer to the customer the maintenance center transmits to the customer at least one statement for clarification of the falling below or exceeding of the threshold value of the installation capacity utilization for the availability of the elevator or escalator installation, or the maintenance center transmits to the customer at least one statement for upgrade cost or elimination of the falling below or exceeding of the threshold value of the installation capacity utilization, or the maintenance center transmits to the customer at least one invoice for this upgrade, in the protocol with respect to the installation capacity utilization. The customer, to whom this protocol is indeed familiar and who can read and understand it, recognizes the enhancement, which is connected with the investment, of the customer's own use.

Advantageously, through detection and debiting of the installation capacity utilization in short maintenance periods a corresponding increase in the frequency of maintenance payments by the customer takes place. Within a maintenance period there are on the one hand maintenance calls to the elevator or escalator installation by the maintenance engineer and on the other hand there is the provision to the customer of invoices of the person instructed with maintenance of the elevator or escalator installation. The length of the maintenance period is freely selectable and is carried out, for example, at regular intervals. Preferably, the length of the maintenance periods is smaller than a year, preferably it amounts to a quarter, more preferably a month, still more preferably a week. Advantageously, the customer settles a transmitted invoice by at least one maintenance payment. Advantageously, through electronic transmission of the invoice to the customer an electronically arranged remittance of a maintenance payment to an account of the person instructed with the maintenance of the elevator or escalator installation is carried out.

For a more complete understanding of the elevator of the present invention, reference is made to the following detailed description and accompanying drawings in which the presently preferred embodiments of the invention are illustrated by way of example. That the invention may be embodied in several forms without departing from the spirit or essential characteristics thereof, it is expressly understood that the drawings are for purposes of illustration and description only, and are not intended as a definition of the limits of the invention. Throughout the following description and drawings, identical reference numbers refer to the same component throughout the several views.

### BRIEF DESCRIPTION OF THE DRAWING

FIG. 1 shows a schematic illustration of the steps of the method for maintenance of an elevator or escalator installation.

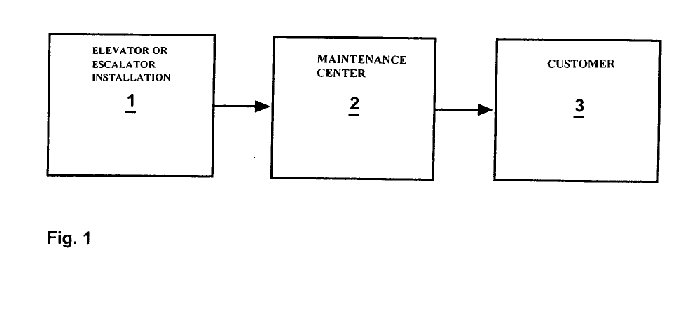

### DETAILED DESCRIPTION OF THE INVENTION

The elevator or escalator installation is denoted by the reference numeral 1, the maintenance center is denoted by reference numeral 2 and the customer is denoted by the reference numeral 3. The elevator or escalator installation, the maintenance center and the customer are arranged physically separately from one another. Data transmitted between the elevator or escalator installation, the maintenance center and the customer are illustrated by extended arrows.

The elevator or escalator installation 1 is arranged in any building and usually comprises at least one elevator or at least one escalator. It can be any elevator installation with components such as a cage for movement of passengers or goods between storeys of the building, a drive for movement of the cage and a control device for controlling the drive. It can be any escalator installation with steps for movement of passengers or goods, balustrade, drive for movement of the steps and a control device for control of the drive.

The elevator or escalator installation 1 is equipped with a data transmission device for remote monitoring. For example, the data transmission device is a modem which is connected with a public telephone network and enables electronic feed of performance-relevant data of the elevator or escalator installation into the public telephone network. With knowledge of the present invention it is obviously also possible to use any medium for data transmission, such as postal transmission of a data carrier such as a compact disc. In this case the data transmission device is a writing apparatus for writing a compact disc.

Performance-relevant data of the elevator or escalator installation I are, for example:

the degree of availability of the elevator or escalator installation,

the total number of journeys executed by the elevator or escalator installation (journey number),

the total number of kilometers traveled by the elevator or escalator installation (travel distance),

the distribution in time of the journeys of the elevator or escalator installation, for example the number of journeys per unit hour,

the distribution in space of the journeys of the elevator installation, for example the number of journeys per destination story,

the total number of maintenance calls,

the term of the next maintenance call,

the total number of faults in the elevator or escalator installation that have occurred,

the reasons for the faults in the elevator or escalator installation, and

the repairs that have been necessary as well as the cost of the material occurring in that case.

These performance-relevant data are detected per maintenance period or for the previous operating period of the elevator or escalator installation. The maintenance period can be selected as desired. For example, it amounts to a week, a month or a year. The performance-relevant data can be uniquely identified. For example, the performance-relevant data are differentiated according to quality and quantity.

The maintenance center 2 is arranged at any distance from the elevator or escalator installation. For example, a number of elevator installations are maintained by the maintenance center. The maintenance center is, for example, a call center with at least one data transfer device and at least one data processing system. The data transfer device is, for example, a modem, which is connected with the public telephone network, or a reading apparatus of a data carrier, such as a compact disc.

Performance-relevant data of an elevator or escalator installation I are transferred to the maintenance center 2. The individual elevator installations and the maintenance center are, for example, uniquely identifiable. The data transfer devices of the elevator or escalator installation and the maintenance center, for example, communicate with one another. The data are transferred by, for example, Internet protocol. Through construction of an Internet connection between the elevator or escalator installation and the maintenance center, performance-relevant data of an elevator or escalator installation are transferred by way of the public telephone network to the maintenance center. Obviously, with knowledge of the present invention it is also possible to use a telephone landline for transmission of the performance-relevant data between the elevator or escalator installation and the maintenance center. It is also possible to provide additional identification means such as the interrogation and checking of passwords before transmission of the performance-relevant data. Thus, protective means such as a firewall can also be used with the elevator or escalator installation or maintenance center. The performance-relevant data can also be transmitted in coded form. Finally, the performance-relevant data can also be transmitted as a postal despatch of a data carrier, such as a compact disc. The performance-relevant data can be transmitted at any intervals in time. Thus, a real-time transmission via landline is possible, but an hourly, daily, weekly or even monthly transmission is also possible on an electronic path and/or by post.

In the maintenance center 2 the performance-relevant data are linked by means of the data processing system with at least one operating parameter to form an installation capacity utilization. For this purpose the data processing system comprises at least one memory and at least one processor. At least one software is stored in the memory, which software is executed by the processor. An operating parameter is similarly stored in the memory. For example, the operating parameter is a component of the software. The performance-relevant data are read in by the software and linked with the operating parameter by means of at least one computation rule.

The operating parameter of the elevator or escalator installation is a physical condition and relationship which influence the operation and performance of the elevator or escalator installation. Operating parameters of the elevator or escalator installation are, for example:

the number of elevators/escalators of the elevator or escalator installation,

the number of stories served,

the distance from one storey to the next story,

the number of passengers to be served per story,

the kind of control device and the passenger interfaces, and

the number of calls to be served,

and per elevator there are considered:

the kind of drive (for example the maximum speed, details with respect to travel graph line, for example by means of acceleration and jolt, or travel times between stops, or specific paths),

the kind of cage (for example, number of decks, size, maximum laden weight, maximum number of persons), and

the kind of cage doors (for example width, opening time, time staying open and closing time).

As a rule the person instructed with the maintenance of the elevator or escalator installation ascertains several operating parameters. The operating parameters can be uniquely identified. For example, the operating parameters are differentiated, similarly to the performance-relevant data, according to quality and quantity.

From the performance-relevant data, for example, the distribution in time of the journeys, which have been carried out, of an elevator installation are identified and linked with the two operating parameters of number of elevators as well as kind of cage. From the number of elevators and the kind of drive, for example, a maximum number of journeys, which can be carried out, per unit hour is ascertained and compared with the distribution in time of the journeys that have been carried out, i.e. the maximum number of journeys able to be performed per unit hour. The result of this comparison is a statement in percent of the journey capacity utilization of the installation.

The performance-relevant data and the installation capacity utilization are part of the maintenance contract and vary depending on the respective kind of maintenance contract and customer. For example, distinction is made between the two following maintenance contracts:

“Pay per use”, where the customer pays for the transport performance, which is produced by the elevator or escalator installation, in dependence on the total number of journeys performed by the elevator or escalator installation and/or the total number of kilometers traveled by the elevator or escalator installation. In that case the costs per journey can vary. The costs of the individual journeys are, for example, degressive with increasing journey number. Frequent travelers thus travel more favorably.

“Secure mover”, where a specific degree of availability of the elevator or escalator installation is guaranteed to the customer. The degree of availability extends from, for example, 95 to 100%. Depending on the respective customer need, the guarantee can apply during 24 hours and 7 days per week or only during specific business times or only during specific predefined peak periods. If the guarantee cannot be fulfilled, predefined penalties are payable.

Thus, performance-relevant data detected in accordance with the maintenance contract are linked with an operating parameter and converted into an installation capacity utilization. The expert with knowledge of the invention can obviously realize any combinations and variations of the two exemplified maintenance contracts.

The customer 3 is domiciled anywhere. For example, the customer is the owner or user of the elevator installation. The customer has at least one data transmission device which is, for example, a modem connected with the public telephone network or is a reading apparatus of a data carrier, such as a compact disc.

The performance-relevant data of the elevator or escalator installation are thus ascertained in a remote monitoring and evaluated in a maintenance center 2 in accordance with an operating parameter and the resulting installation capacity utilization is transmitted to the customer 3 as a protocol. The maintenance center and the individual customer are, for example, uniquely identifiable. For example, the data transmission devices of the maintenance center and the customer communicate with one another. The protocol is transferred, for example, by Internet protocol. Through construction of an Internet connection between the maintenance center and customer the protocol of an installation capacity utilization is electronically transferred to the customer by way of the public telephone network. A postal transmission of the protocol is obviously also possible.

The customer 3 obtains, by the protocol with respect to the installation capacity utilization, numerous items of information about the customer service, which is being used, from the provision of a faultlessly functioning elevator or escalator installation. The protocol has, for example, the degree of availability of the elevator or escalator installation. The protocol has, for example, the total number of journeys of the elevator or escalator installation. The protocol has, for example, the distribution in time or space of the journeys of the elevator or escalator installation. The protocol has, for example, the total number of and the reasons for faults in the elevator or escalator installation. The protocol has, for example, the number of previous maintenance calls and the term of the next maintenance visit.

Advantageously an invoice for the installation capacity utilization is listed in the protocol. This invoice is, by virtue of the detected performance-relevant data, directly geared to the installation capacity utilization. An invoice for maintenance work divided into fixed costs and additional costs, which in the past were difficult to estimate, is not presented to the customer 3, but he receives an invoice with respect to the availability, which has been individually consumed by him, of the elevator or escalator installation. The maintenance calls and the setting of invoices are not coupled with one another. With knowledge of the present invention it is, however, possible to couple the maintenance calls and the setting of the invoices with one another. The expert here has numerous possibilities of organizing the maintenance calls and the setting of the invoices in terms of time. For example, a setting of invoices with minimal time delay of a few hours or days as a real reflection of the customer service produced takes place. Advantageously, setting of an invoice is carried out after consumption of a customer service predefined in the maintenance contract. For example, an invoice is effected after fulfilment of a predetermined journey number of, for example, 10,000 journeys or after covering a predetermined travel path of, for example, 1,000 kilometers.

Contact between the customer and the person instructed with maintenance of the elevator or escalator installation is intensified by the method according to the invention. The maintenance person, who is usually identical with the operator of the maintenance center, intensifies their knowledge of the behavior, needs and wishes of each individual customer through the detection and evaluation of the performance-relevant data. This makes possible the build-up of a customer relationship management by individualized marketing activities. Advantageously, it is possible for the person through the deep knowledge about the customer requirement to work out for the customer an individual upgrade offer whereby a performance enhancement of the elevator or escalator installation or a reduction in maintenance and servicing costs follows. By upgrade offer there is understood a modernization of the elevator or escalator installation with the objective of increasing customer use.

For example, a computation rule is contained in the software, according to which the ratio of the number of journeys performed to the number of maximum journeys able to be performed defines a journey capacity utilization of the installation, which installation capacity utilization is sub-optimal in the case of falling below or exceeding at least one threshold value, i.e. the availability of the elevator installation is influenced in disadvantageous manner. For example, in the case of an installation capacity utilization below a threshold value of 10%, constant loss occurs, whereas excess wear arises in the case of an installation capacity utilization above a threshold value of 95%. For example, in the case of falling below or exceeding the threshold value of the journey capacity utilization of the installation an adaptation of the control device to the amount of journeys effectively undertaken by the passengers or goods is carried out. A further threshold value of the installation capacity utilization is a number of faults as well as a number of identical or similar reasons for faults. For example, frequent door faults occur, which has a disadvantageous influence on the availability of the elevator installation and is picked up by an appropriate threshold value of “number of door faults per week” and is communicated to the customer in the protocol. An offer for door modernization for elimination of these door faults is, for example, presented to the customer in the case of repetition of these door faults.

Advantageously, the falling below or exceeding of the threshold value is ascertained by simulation. This simulation of the installation capacity utilization is carried out in accordance with performance-relevant data and operating parameters on a data processing system with at least one memory and at least one processor. A simulation software, which is executed by the processor, is stored in the memory. The performance-relevant data are linked with at least one changed operating parameter to form a simulated installation capacity utilization. For example, an iterative variation of at least one changed operating parameter is carried out in order to achieve an installation capacity utilization within two threshold values. Preferably, an optimization is carried out in which from a number of possibilities only one or a few preferred—for example according to predetermined target criteria—best-possible operating parameters are used. This optimization is repeated until the changed operating parameter fulfils the requirement of the installation capacity utilization.

The corresponding upgrade offer comprises at least one statement for clarification of the falling below or exceeding of the threshold value of the installation capacity utilization for the availability of the elevator or escalator installation or it comprises at least one statement with respect to the upgrade cost for elimination of the falling below or exceeding of the threshold value of the installation capacity utilization or it comprises at least one invoice for this upgrade. This upgrade offer, i.e. a statement for clarification of the falling below or exceeding of a threshold value of the installation capacity utilization or a statement with respect to upgrade cost or an invoice for this upgrade, is transmitted to the customer by the protocol with respect to the installation capacity utilization. The customer, who is certainly familiar with this protocol and can read and understand it, recognizes the increase, which is connected with the investment, in the customer's own use.

Through the method according to the invention there is made possible a rejection of the traditional annular setting, which is to be carried out in advance, of the cost calculation for the maintenance services. Through determining and invoicing the installation capacity utilization in maintenance periods which are shorter than a year there is made possible a corresponding increase in the frequency of maintenance payments by the customer. For example, maintenance payments take place in rhythm with the maintenance periods, i.e. preferably quarterly, preferably monthly, preferably weekly. Obviously, with knowledge of the present invention also longer or shorter or even irregular maintenance periods are possible.

Advantageously, the customer undertakes maintenance payments electronically. In that case an invoice electronically transmitted to the customer is settled by at least one maintenance payment to the person instructed with maintenance of the elevator or escalator installation. For example, the individual invoices as well as a customer account and a person account are uniquely identifiable. For example, the data transfer devices of the customer and a bank of the customer communicate with one another. For example, a request for a maintenance payment is transferred by Internet protocol from the customer to the customer's bank. Through build-up of a secure Internet connection between customer and the customer's bank the request for the maintenance payment is transferred electronically by way of the public network to the bank of the customer. The bank of the customer in turn arranges, in known manner, remittance of the maintenance payment from the account of the customer to the account of the person instructed with maintenance of the elevator or escalator installation.

While the invention has been illustrated and described above, it is not intended to be limited to the details shown since various modifications and structural changes may be made without departing in any way from the spirit of the present invention.

Without further analysis, the foregoing will so fully reveal the gist of the present invention that others can, by applying current knowledge, readily adapt various applications without omitting features that, from the standpoint of prior art, merely constitute essential characteristics of the generic or specific aspects of this invention.

What is claimed is new and desired to be protected by Letters Patent as set forth in the appended claims.

In the claims:

1. A method of maintaining an elevator installation or an escalator installation with a maintenance center physically separate from the elevator or escalator installation, the method comprising the steps of:
transferring performance-relevant data from the elevator or escalator installation to the maintenance center;
linking the performance-relevant data in the maintenance center with at least one operating parameter to form an installation capacity utilization; and
transmitting a protocol with respect to the installation capacity utilization to a customer separate from the maintenance center.

2. The method according to claim 1, including transmitting the protocol at least one of electronically and as a postal transmission to the customer.

3. The method according to claim 1, further including generating an invoice in the protocol with respect to at least one of the installation capacity utilization that has been used, a degree of availability of the elevator or escalator installation, a total number of journeys of the elevator or escalator installation, a distribution in time or space of the journeys of the elevator or escalator installation, a total number of and reasons for faults in the elevator or escalator installation and a number of previous maintenance calls and a term of a next maintenance call.

4. The method according to claim 3, further including settling the invoice with respect to the installation capacity utilization that has been used by at least one maintenance payment of the customer.

5. The method according to claim 4, including transmitting the invoice electronically to the customer and electronically remitting at least one maintenance payment to an account of a person responsible with the maintenance of the elevator or escalator installation.

6. The method according to claim 3, including transmitting the invoice electronically to the customer and electronically remitting at least one maintenance payment to an account of a person responsible with the maintenance of the elevator or escalator installation.

7. The method according to claim 3, further including transmitting the invoice with respect to the installation capacity utilization that has been used in maintenance periods of less than one year.

8. The method according to claim 7, including transmitting the invoice quarterly.

9. The method according to claim 8, including transmitting the invoice monthly.

10. The method according to claim 9, including transmitting the invoice weekly.

11. The method according to claim 3, further including transmitting the invoice after consumption of predefined customer work.

12. The method according to claim 7, further including transmitting the invoice after consumption of predefined customer work.

13. The method according to claim 3, including transmitting the invoice at least one of after fulfilment of a predefined number of journeys and after a predefined travel distance has been covered.

14. The method according to claim 1, further including providing at least one threshold value of the installation capacity utilization via the maintenance center and transmitting this threshold value to the customer in the protocol with respect to installation capacity utilization.

15. The method according to claim 14, further including transmitting at least one statement for clarification of falling below or exceeding the threshold value of the installation capacity utilization to the customer in the protocol, transmitting at least one statement with respect to upgrade cost to the customer in the protocol, and transmitting at least one invoice for the upgrade to the customer in the protocol.

16. A system for maintenance of an elevator installation or an escalator installation, comprising:
a maintenance center physically separate from the elevator or escalator installation;
at least one data transfer device operative to transfer performance-relevant data from the elevator or escalator installation to the maintenance center;
at least one data processing system arranged to link the performance-relevant data with at least one operating parameter to form an installation capacity utilization; and
at least one data transfer device operative to transmit a protocol with respect to the installation capacity utilization to a customer separate from the maintenance center.
